(19) United States
(12) Patent Application Publication
(10) Pub. No.: US 2009/0130417 A1
(43) Pub. Date: May 21, 2009

(54) Thin-walled light engine cover for vehicles

(75) Inventors: Itsuro Maeda, Aichi-ken (JP); Kenji Shiga, Shiga-ken (JP); Yasuto Fujii, Shiga-ken (JP); Satoshi Sakai, Shiga-ken (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-ken (JP); TOYO BOSEKI KABUSHIKI KAISHA, Osaka (JP)

(21) Appl. No.: 12/292,284

(22) Filed: Nov. 14, 2008

(30) Foreign Application Priority Data
Nov. 16, 2007 (JP) 2007-298685

(51) Int. Cl. B32B 27/34

(52) U.S. Cl. 428/220

(57) ABSTRACT

A thin-walled light resin composition engine cover has reduced mass and thickness while retaining radiated sound reduction effects, heat resistance, and mechanical properties. The cover has an average thickness of 2.0 mm or less. The resin composition includes (a) a polyamide resin composed of essentially at least one of scrap of vehicle airbag fabric made of nylon 66 containing a copper-based stabilizer and vehicle airbag fabric recycled, (b) a modified polypropylene resin, (c) a reinforcement material, (d) a metal deactivator and a photo-thermal stabilizer, and (e) a viscosity regulator. The resin composition has a melt flow rate of not less than 40 g/10 min.

### INCORPORATION BY REFERENCE

This disclosure of Japanese Patent Application No. 2007-298685, filed on Nov. 16, 2007, including the specification, drawings, and abstract is incorporated by reference in its entirety.

### BACKGROUND OF THE INVENTION

1. Field of the Invention

The present invention relates to a thin-walled light engine cover for vehicles.

2. Description of the Related Art

Recently, vehicle engines are constructed in such a manner that an engine cover is provided on a cylinder head cover. The engine cover mainly functions to reduce the sound radiated from the engine. Furthermore, the engine cover functions as a cover so that the engine is covered therewith and is not visible. Thus, it increases the decorative design of an engine compartment.

The engine cover for reducing the radiated sound should be imparted with heat resistance so as to be usable in an atmosphere over the cylinder head, and also with rigidity or such mechanical properties so as to be able to endure extreme vibrations. For this reason, as a hard resin for an engine cover, a polyamide resin, including glass fiber- or inorganic filler-reinforced polyamide 6, or polyamide 66, has been typically used. The engine cover has an average thickness of about 2.5˜3.0 mm, which is regarded as thick.

These days, however, vehicles are required to have environmentally friendly performance. So, the engine cover, which is a peripheral part of the engine, while maintaining an intrinsic function as a cover, should take into consideration environmentally friendly performance, and should be reduced in mass with the use of a recycled resin material. As such, when the engine cover is manufactured using the recycled resin material or is reduced in mass, resources are effectively used and high fuel efficiency is achieved.

An engine cover reduced in mass is devised using a low packed reinforced polyamide composite material comprising a polyamide resin and about 2% by mass swelling lamellar silicate salt dispersed on the molecular level therein (e.g., Japanese Unexamined Patent Publication Nos. 2007-31484 and 11-132102).

However, such a polyamide composite material has poor impact resistance not only in typical use conditions, but also at low temperatures. Because the polyamide composite material is low packed reinforced polyamide composed mainly of polyamide, it exhibits high absorptiveness, which is an intrinsic property of polyamide, and has a high saturated moisture absorption rate. As a result, the above material changes into a high moisture absorption state under actual use conditions within an engine compartment. Thus, the engine cover made from the above polyamide composite material drastically decreases the mechanical strength or elastic modulus, and has poor rigidity which is typically required for a cover, and has many functional problems.

In addition, as a resin composition for realizing low specific gravity and low absorption properties, a polyamide resin composition including a polyolefinic copolymer is known (e.g., Japanese Patent No. 2794943).

As such, the above polyamide resin composition is deemed fit for application to an engine cover. However, in the case where such a polyamide resin composition is used in an engine cover, a mass reduction effect is shown only by the low specific gravity of the resin. Furthermore, when the polyamide resin composition is used in an engine cover, injection moldability (ease of filling) into a mold having a shape of an engine cover is inadequate to use for the polyolefinic copolymer, and thus it is difficult to obtain a thin-walled product.

Japanese Patent No. 3887354 and Japanese Unexamined Patent Publication No. 2000-17169 disclose an engine cover made from a polymer alloy comprising polyamide and polyolefin. However, these patents do not disclose that the engine cover can reduce the mass for the thin-walled engine cover. Therefore, research and improvement thereon are not found therein.

Meanwhile, with the goal of reducing the mass of the engine cover, the present inventors have uniquely tried to devise a polyamide composition for reducing the specific gravity of the engine cover without deteriorating functions of the engine cover. Furthermore, with the goal of increasing the mass reduction effect of the engine cover, a lot of effort has been directed to a thin-walled and reinforced shape of the engine cover for avoiding the deterioration of mechanical properties of the engine cover. However, the polyamide material under study is poor as pertains to the ease of filling a mold having a shape of a thin-walled engine cover therewith, and needs to be Furthermore improved.

Furthermore, there remains the task of designing a polyamide resin composition having a low specific gravity using recycled materials in consideration of environmentally friendly performance by effectively using resources.

Moreover, the present inventors have thoroughly studied the reuse of vehicle airbag fabric made of nylon 66 by collecting such fabric and then pelletizing them. However, nylon 66 has a high molecular weight with a high melt viscosity, and has low flowability for injection molding, thus making it difficult to fill a mold therewith. Furthermore, nylon 66 for an airbag contains a copper-based stabilizer in order to realize high thermal aging resistance. Although the copper-based stabilizer is very effective in terms of increasing the thermal aging resistance of nylon 66, it negatively affects the polyolefinic copolymer in the mixture of nylon 66 and polyolefinic copolymer. Hence, when a resin molded body made from a mixture of nylon 66 and polyolefinic copolymer is maintained at 150° C. for a long period of time, the entire resin molded body becomes thermally degraded, undesirably deteriorating the mechanical properties, and whitening the outer appearance.

Accordingly, in order to use recycled nylon 66 in the resin composition for an engine cover, there is a need to deactivate the copper-based stabilizer contained in the recycled nylon 66. Furthermore, to form the thin-walled engine cover from the resin composition containing recycled nylon 66, the ease with which a mold may be filled with molten resin should be improved.

### SUMMARY OF THE INVENTION

Therefore, the present invention has been made keeping in mind the above problems encountered in the related art, and provides a thin-walled light engine cover, in which, even when recycled nylon 66 is used, a reduction in mass and thickness may be realized while retaining radiated sound reduction effects, heat resistance and mechanical properties as in conventional engine covers. Furthermore, problems with temporal decrease of rigidity or poor outer appearance under actual use conditions may be solved.

Thorough research into such engine covers, carried out by the present inventors, resulted in the finding that a resin composition comprising a polyamide resin composed essentially of at least one of scrap of vehicle airbag fabric made of nylon 66 containing a copper-based stabilizer and recycled vehicle airbag fabric made of nylon 66 containing a copper-based stabilizer, a modified polypropylene resin, and a reinforcement material may be molded into a shape of a thin-walled engine cover having an average thickness of 2.0 mm or less, and is resistant to change in color at high temperatures of 150° C., thus completing a thin-walled light engine cover for vehicles.

(1) That is, in a thin-walled light engine cover for vehicles, which is produced from a resin composition, in accordance with the present invention, the resin composition includes:

(a) a polyamide resin composed of essentially at least one of scrap of vehicle airbag fabric made of nylon 66 containing a copper-based stabilizer and recycled vehicle airbag fabric made of nylon 66 containing a copper-based stabilizer;

(b) a modified polypropylene resin, obtained by graft copolymerizing an unsaturated carboxylic acid or a derivative thereof onto a crystalline polypropylene resin;

(c) a reinforcement material;

(d) a metal deactivator and a photo-thermal stabilizer; and

(e) a viscosity regulator, wherein:

in the resin composition, the components (a)˜(c) are mixed at a mass ratio of (a)/(b)/(c) of 45˜80/15˜35/5˜20; in the resin composition, based on 100 parts by mass of a total of the components (a)˜(c), the component (d) is used in an amount of 0.005˜10 parts by mass and the component (e) is used in an amount of 0.05˜10 parts by mass; the resin composition has a melt flow rate of not less than 40 g/10 min, which is measured under a load of 2160 g at a temperature 10° C. higher than a melting point of the component (a) as obtained through differential scanning calorimetry at a heating rate of 20° C./min; and the engine cover has an average thickness of 2.0 mm or less.

According to the present invention, a thin-walled light engine cover for vehicles is produced from the above resin composition comprising the components (a)˜(e) at a predetermined mixing ratio. Thus, even when the scrap of vehicle airbag fabric made of nylon 66 containing a copper-based stabilizer or the recycled vehicle airbag fabric made of nylon 66 containing a copper-based stabilizer are used, as shown later in the examples, a thin-walled light engine cover having an average thickness of 2.0 mm or less can be realized, while retaining radiated sound reduction effects, heat resistance, and mechanical properties as in conventional engine covers. Furthermore, problems with temporal decrease of rigidity or poor outer appearance under actual use conditions can be solved.

The scrap of vehicle airbag fabric made of nylon 66 shows the rest of nylon 66 fabric left when the vehicle airbag made of nylon 66 is manufactured.

(2) In the constitution (1), it is preferable that the metal deactivator is at least one element and/or a composite comprising two or more elements selected from the group consisting of salicylic acid derivatives, hydrazine derivatives, oxalic acid derivatives, and diamine derivatives. Also, it is preferable that the photo-thermal stabilizer is at least one selected from the group consisting of hindered phenolic stabilizers, phosphorus-based stabilizers, benzotriazole-based stabilziers, benzophenone-based stabilizers, and amine-based stabilizers.

(3) In the constitution (1) or (2), it is preferable that the viscosity regulator is at least one selected from the group consisting of aliphatic dicarboxylic acids, alicyclic dicarboxylic acids, and aromatic dicarboxylic acids.

(4) In any one of the constitution (1) to (3), it is preferable that the reinforcement material includes a plate-like inorganic filler and a fibrous reinforcement material.

(5) In the constitution (4), it is preferable that the plate-like inorganic filler and the fibrous reinforcement material are mixed at a mass ratio of plate-like inorganic filler/fibrous reinforcement material of 35˜65/35˜65.

(6) In any one of the constitution (1) to (5), it is preferable that a flexural modulus under equilibrium moisture absorption at 65% relative humidity is 2.5 GPa or more.

(7) In any one of the constitution (1) to (6), it is preferable that an equilibrium moisture absorption rate at 65% relative humidity is 2.5% or less.

Therefore, the thin-walled light engine cover for vehicles according to the present invention is advantageous because recycled nylon 66 is used, thus realizing the effective use of resources, to make the engine cover thin-wall and light, resulting in improved fuel efficiency.

### BRIEF DESCRIPTION OF THE DRAWINGS

The above and other objects and features of the present invention will become apparent from the following description of specified embodiment, given in conjunction with the accompanying drawings, in which:

FIG. 1 is a perspective view showing an engine cover according to an embodiment of the present invention; and

FIG. 2 is a partial cross-sectional view showing a state in which the engine cover of FIG. 1 is attached to a cylinder head cover.

### DESCRIPTION OF THE SPECIFIC EMBODIMENTS

Various embodiments of the present invention will now be described in detail with reference to the accompanying drawings.

According to the present invention, a thin-walled light engine cover for vehicles is produced from a resin composition comprising (a) a polyamide resin composed essentially of at least one of scrap of vehicle airbag fabric made of nylon 66 containing a copper-based stabilizer and recycled vehicle airbag fabric made of nylon 66 containing a copper-based stabilizer, (b) a modified polypropylene resin obtained by graft copolymerizing an unsaturated carboxylic acid or a derivative thereof onto a crystalline polypropylene resin, (c) a reinforcement material, (d) a metal deactivator and a photo-thermal stabilizer, and (e) a viscosity regulator.

The polyamide resin (a) is composed essentially of at least one of scrap of vehicle airbag fabric made of nylon 66 containing a copper-based stabilizer and recycled vehicle airbag fabric made of nylon 66 containing a copper-based stabilizer (hereinafter, at least one of scrap of vehicle airbag fabric made of nylon 66 and recycled vehicle airbag fabric made of nylon 66 containing a copper-based stabilizer is referred to as ‘recycled nylon 66’).

Examples of the copper-based stabilizer contained in the recycled nylon 66 include copper halides, including cuprous (cupric) iodide, cuprous (cupric) chloride, and cuprous (cupric) acetate. Furthermore, the copper halide may be used in the form of a composite of copper halide and 2-mercaptobenzoimidazole or 2-mercaptobenzothiazole.

The polyamide resin includes polyamide listed below, as needed. Examples of the polyamide resin include, but are not limited to, polyamide resins prepared from aliphatic, alicyclic or aromatic diamine, including hexamethylenediamine, decamethylenediamine, dodecamethylenediamine, 2•2•4- or 2•4•4-trimethylhexamethylenediamine, 1•3- or 1•4-bis(aminomethyl)cyclohexane, bis(p-aminocyclohexylmethane) and m- or p-xylenediamine with aliphatic, alicyclic or aromatic dicarboxylic acid, including adipic acid, sberic acid, sebacic acid, cyclohexanedicarboxylic acid, terephthalic acid or isophthalic acid, polyamide resins prepared from said diamine with aminocarboxylic acid, including 6-aminocaproic acid, 11-aminoundecanoic acid or 12-aminododecanoic acid, polyamide resins prepared from said diamine with lactam including ε-caprolactam or ω-dodecalactam, polyamide resin copolymers thereof, and polyamide resin mixtures thereof. Specific examples of the polyamide resin include polycarproamide (nylon 6), polydodecanoamide (nylon 12), polyhexamethyleneadipamide (nylon 6•6), polyhexamethyleneazelamide (nylon 6•9), polyhexamethylenesebacamide (nylon 6•10), polyhexamethylenedodecanoamide (nylon 6•12), polyxyleneadipamide, polyhexamethyleneterephthalamide, polyphenylenephthalamide, nylon 6/6•6, poly(xyleneadipamide/hexamethyleneadipamide), etc. In particular, the polyamide composition is composed of recycled nylon 66 and nylon 6 at a mass ratio of recycled nylon 66/nylon 6 of 10˜90/10˜90, preferably 30˜70/30˜70, and more preferably 40˜60/40˜60. Furthermore, in the components other than the recycled nylon 66, vehicle airbag fabric recycled may also be used.

In consideration of heat resistance of an engine cover, the melting point of the polyamide resin (a), which is measured by differential scanning calorimetry (DSC) at a heating rate of 20° C./min, is in the range of 200° C. or higher. The molecular weight of the polyamide resin is not particularly limited. Although a polyamide resin having a relative viscosity of 1.8 or higher (as measured in a 98% sulfuric acid solution according to JIS K 6810-1970) may be used, the use of a polyamide resin having a relative viscosity of 2.2 or higher is preferable in order to achieve mechanical properties required for an engine cover. The polyamide resin may include a branched copolymer within a range that does not deteriorate moldability thereof, depending on the types of molded product. Particularly useful is polyamide having a relative viscosity, as measured in a 1% solution of 96% sulfuric acid, in the range of 2.2˜3.5.

The polypropylene resin used in the modified polypropylene resin (b) may be either isotactic or atactic, but isotactic is preferable. Furthermore, a crystalline polypropylene resin having an intrinsic viscosity of 2.0˜3.0 is preferable. In addition, not only a homopolymer, but also a random or block copolymer of 80 mol % or more of propylene and olefin may be used. The polypropylene resin has a melt flow rate (MFR) of 0.2˜3.0 g/10 min according to ASTM D-1238-62T (230° C., load: 2160 g).

Useful for the preparation of the modified polypropylene resin (b), a modifier for modifying (graft copolymerizing) the polypropylene resin is selected from among unsaturated carboxylic acids and derivatives thereof, and examples of the unsaturated carboxylic acid include acrylic acid, methacrylic acid, α-ethylacrylic acid, maleic acid, fumaric acid, itaconic acid, citraconic acid, tetrahydrophthalic acid, methyltetrahydrophthalic acid, endo-bicyclo(2,2,1)hept-5-ene-2,3-dicarboxylic acid (nadic acid), and methyl-endo-cis-bicyclo (2,2,1)hept-5-ene-2,3-dicarboxylic acid (methylnadic acid). Examples of the unsaturated carboxylic acid derivative include reactive derivatives of the above acid, including acid halides, amides, imides, acid anhydrides, and esters. Specific examples thereof include malenyl chloride, maleimide, maleic anhydride, citraconic anhydride, monomethyl maleate, dimethyl maleate, and glycidyl maleate. Among them, unsaturated dicarboxylic acid or unsaturated dicarboxylic anhydride may be appropriately used. Particularly useful is maleic acid, nadic acid, or an acid anhydride thereof. The modifier is used in an amount of 0.05˜2.0 parts by mass based on 100 parts by mass of the polypropylene resin.

The method for reacting (graft copolymerization) the modifier with the polypropylene resin is not particularly limited, but should be conducted so that the gel is not contained in the modified polypropylene resin. Furthermore, low flowability results in poor processability. Specifically, the polypropylene resin, the modifier, and a radical generator are mixed and melt kneaded to allow them to graft reaction, thereby obtaining a modified polypropylene resin. Examples of the radical generator include known organic peroxides or diazo compounds. Specific examples thereof include benzoyl peroxide, dicumyl peroxide, di-t-butyl peroxide, t-butylcumyl peroxide, cumene hydroperoxide, and azobisisobutyronitrile. The radical generator is used in an amount of 0.02˜0.5% by mass based on the amount of the polypropylene resin.

The reinforcement material (c) is used in the form of a combination of a plate-like inorganic filler and a fibrous reinforcement material. Examples of the plate-like inorganic filler include talc, wollastonite, mica, silica, clay and calcium carbonate, which may be used alone or in combinations thereof. Taking into consideration a balance between mass reduction, mechanical properties and outer appearance of the molded products, talc is particularly useful. Examples of the fibrous reinforcement material include glass fiber, carbon fiber, and aramide fiber, which may be used alone or in combinations thereof.

In the reinforcement material, the plate-like inorganic filler and the fibrous reinforcement material are mixed at a mass ratio of plate-like inorganic filler/fibrous reinforcement material of 35˜65/35˜65. If the amount of fibrous reinforcement material is too large, warpage of molded products is increased. Conversely, if the amount thereof is too small, the degree of improvement in flexural strength or flexural modulus is inadequate.

In the resin composition, the components (a)˜(c) are mixed at a mass ratio of (a)/(b)/(c) of 45˜80/15˜35/5˜20, and preferably 50˜70/20˜30/10˜20. As in the case in which the (a)/(b)/(c) is 50˜70/20˜30/10˜20, when the proportion of the component (b) is 20 or more, an equilibrium moisture absorption rate (saturated moisture content) at 65% relative humidity is lowered, and thus flexural modulus or thermal deformation temperature is increased in actual use (in saturated moisture absorption).

The melt flow rate (MFR) of the resin composition, which is measured under a load of 2160 g at a temperature 10° C. higher than the melting point of the component (a) as obtained through DSC at a heating rate of 20° C./min, is not less than 40 g/10 min. The upper limit of the MFR is 80 g/10 min, preferably 65 g/10 min, and more preferably 55 g/10 min. If the MFR is too low, it is difficult to ensure the ease of filling a mold with the resin composition in the injection molding process. Conversely, if the MFR is too high, flowability is increased, and thus the generation of burrs in molded products is facilitated, undesirably causing production problems and decreasing impact resistance strength.

In component (d), the metal deactivator and the photo-thermal stabilizer function to prevent the thermal degradation of modified polypropylene due to the copper-based stabilizer in the recycled nylon 66, and to prevent the deterioration of the entire properties of the resin composition.

The metal deactivator is preferably at least one element and/or a composite comprising two or more elements selected from the group consisting of salicylic acid derivatives, hydrazine derivatives, oxalic acid derivatives, and diamine derivatives.

The photo-thermal stabilizer is preferably at least one selected from the group consisting of hindered phenolic stabilizers, phosphorus-based stabilizers, benzotriazole-based stabilziers, benzophenone-based stabilizers, and amine-based stabilizers.

The preferred combination of the metal deactivator and the photo-thermal stabilizer includes salicylic acid derivative-based metal deactivator/hindered phenolic stabilizer, hydrazine derivative-based metal deactivator/hindered phenolic stabilizer, oxalic acid derivative-based metal deactivator/hindered phenolic stabilizer, and diamine derivative-based metal deactivator/hindered phenolic stabilizer.

The total amount of the metal deactivator and the photo-thermal stabilizer combined together is set to 0.005˜10 parts by mass, preferably 0.05˜5 parts by mass, and more preferably 0.5˜3 parts by mass, based on 100 parts by mass of the total of the components (a)˜(c).

The viscosity regulator of the component (e) plays a role in facilitating the pouring of the molten resin into a mold having a shape of a thin-walled engine cover with an average thickness of 2.0 mm or less, so as to improve the outer appearance of the engine cover. The viscosity regulator is at least one selected from the group consisting of aliphatic dicarboxylic acids, alicyclic dicarboxylic acids, and aromatic dicarboxylic acids.

The amount of viscosity regulator is set to 0.05˜10 parts by mass, preferably 0.1˜3.0 parts by mass, and more preferably 0.2˜1.0 parts by mass, based on 100 parts by mass of the total of the components (a)˜(c). The viscosity regulator is preferably exemplified by adipic acid.

The resin composition may furthermore include various additives, as needed. Examples of the additives include an impact improver, an anti-thermal aging agent, a UV absorbent, a flame retardant, and other adjuvants.

Below, a preferred embodiment of a method of forming a thin-walled light engine cover for vehicles according to the present invention using the resin composition is described.

As for the components (a)˜(e), the polyamide resin, the modified polypropylene resin, the reinforcement material, the metal deactivator and photo-thermal stabilizer, and the viscosity regulator are mixed under heat. Alternatively, the reinforcement material, the metal deactivator and photo-thermal stabilizer, and the viscosity regulator, or various additives as needed may be added at any stage among an initial stage of mixing, an intermediate stage of mixing, and a final stage of mixing. Alternatively, the polyamide resin and the modified polypropylene resin may be separately melted and then mixed, after which the reinforcement material, the metal deactivator and photo-thermal stabilizer, and the viscosity regulator, or various additives, may be added thereto as needed.

The mixing process may be conducted using a known device. Examples of the device include an impeller-equipped reactor, a single-shaft or twin-shaft screw extruder, a Banbury mixer, and a kneader mixing roll, which may be used alone or in combinations thereof. The heat mixing process is preferably conducted at a temperature not lower than the higher of the two melting points, one of which is the melting point of the polyamide resin, and the other of which is the melting point of the modified polypropylene resin.

The average thickness of the thin-walled engine cover for vehicles, according to the present invention, is 2.0 mm or less. As a result, the mass of the engine cover may be remarkably reduced. The average thickness of the engine cover is preferably 1.8 mm or less. From the point of view of the mass reduction, it is preferred that the average thickness of the engine cover be as thin-wall as possible. However, limitations are imposed on decreasing the average thickness in order to realize the desired moldability or strength, and thus, at present, the lower limit of the average thickness of the engine cover is set at 1.5 mm. Also, the shape or size of the engine cover is not particularly limited.

In the thin-walled engine cover for vehicles according to the present invention, flexural modulus under equilibrium moisture absorption at 65% relative humidity is 2.5 GPa or more, and preferably 3 GPa or more. If the flexural modulus under equilibrium moisture absorption at 65% relative humidity is too low, under actual use conditions for moisture absorption within an engine compartment, mechanical strength or elastic modulus is drastically decreased, and the rigidity or other functions typically required for the cover cannot be ensured.

Furthermore, in the thin-walled engine cover for vehicles according to the present invention, an equilibrium moisture absorption rate at 65% relative humidity is 2.5% or less, preferably 2.3% or less, and more preferably 2.0% or less. If the equilibrium moisture absorption rate at 65% relative humidity is too high, under actual use conditions for the moisture absorption within an engine compartment, mechanical strength or elastic modulus is drastically decreased, and the rigidity or other functions typically required for the cover cannot be ensured.

### EXAMPLES

A better understanding of the present invention may be obtained through the following examples, which are set forth to illustrate, but are not to be construed to limit the present invention.

### Examples 1˜5

### Comparative Examples 1˜8

The following components (a)˜(e) were prepared.

<Component (a): Polyamide Resin>

Nylon 66 (containing 60 ppm copper ions), recycled from scrap of airbag: TR-001TG (available from Toyobo Co., Ltd., relative viscosity: 3.3)

Nylon 6: T-800 (available from Toyobo Co., Ltd., relative viscosity: 2.5)

<Component (b): Modified Polypropylene Resin>

Maleic anhydride-modified polypropylene: MMP-006 (available from Prime Polymer Co., Ltd.)

<Component (c): Reinforcement Material>

Talc: Micron 406 (available from Hayashi Kasei Co., Ltd.)

Mica: Takara Mica M-101 (available from Shiraishi Calcium Kaisha, Ltd.)

Glass Fiber: 03MAFT2A (available from Owens Corning Ltd.)

<Component (d): Metal Deactivator & Photo-Thermal Stabilizer>

Metal Deactivator Salicylic acid derivative ADK STAB CDA-1 (available from ADEKA Corporation)

Metal Deactivator: ADK STAB ZS-27 (available from ADEKA Corporation)

Metal Deactivator Hydrazine-based derivative Irganox MD1024 (available from Ciba Specialty Chemicals Inc.)

Metal Deactivator Oxalic acid derivative Naugard XL-1 (available from Uniroyal Chemicals Ltd.)

Metal Deactivator: Nocrac White (available from Ouchi Shinko Chemical Industrial Co., Ltd.)

Photo-Thermal Stabilizer: Hindered phenolic stabilizer Irganox B1171 (available from Ciba Specialty Chemicals Inc.)

<Component (e): Viscosity Regulator>

Adipic Acid (available from Nacalai Tesque, Inc., reagent)

In Examples 1˜5 the above components (a)˜(e) were weighed and mixed according to a mixing ratio as shown in Table 1 below, and in Comparative Examples 1˜8 the above components (a)˜(e) were weighed and mixed according to a mixing ratio as shown in Table 2 below, after which the resultant mixture was melt kneaded using a twin-shaft screw extruder. In Tables 1 and 2 below, the values of the components (a)˜(c) are mass proportions, the sum of which is 100. Furthermore, in Tables 1 and 2 below, the values of the components (d) and (e) are parts by mass based on 100 parts by mass of the total of the components (a)˜(c).

The melt kneading process was conducted using a 35φ twin shaft type extruder (available from Toshiba Machine Co., Ltd.), under conditions of a cylinder temperature of 260˜290° C., a screw rotation speed of 100 rpm, and a discharge rate of 18 Kg/hr. Also, raw materials with the exception of glass fiber were previously mixed and then fed into a main hopper, and the glass fiber was fed into a side feed inlet from a bent inlet.

TABLE 1

| | | Remark | | Example 1 | Example 2 | Example 3 | Example 4 | Example 5 |
|---|---|---|---|---|---|---|---|---|
| Resin | (a) Polyamide | recycled nylon 66 | TR-001TG | 30 | 30 | 40 | 32 | 30 |
| Composition | | ( ) shows ion content of | Toyobo Co., Ltd. | (18 ppm) | (18 ppm) | (24 ppm) | (19 ppm) | (18 ppm) |
| | | contained copper | | | | | | |
| | | nylon 6 | T-800 | 30 | 30 | 32 | 40 | 30 |
| | | | Toyobo Co., Ltd. | | | | | |
| | (b) Modified | Maleic anhydride-modified | MMP-006 | 27 | 27 | 18 | 18 | 27 |
| | Polypropylene | polypropylene | Prime Polymer Co., Ltd. | | | | | |
| | (c) Reinforcement | Talc | Micron 406 | | 5 | 5 | 5 | 8 |
| | Material | | Hayashi Kasei Co., Ltd. | | | | | |
| | | Mica | M101 | 8 | | | | |
| | | | Shiraishi Calcium | | | | | |
| | | | Kaisha, Ltd. | | | | | |
| | | Glass Fiber | 03MAFT2A | 5 | 8 | 5 | 5 | 5 |
| | | | Owens Corning Ltd. | | | | | |
| | | Others | Montmorillonite | | | | | |
| | (d) Metal | ADK STAB CDA-1 | Metal Deactivator | 1.5 | | | | |
| | Deactivator/Photo- | (ADEKA Corporation) | Salicylic acid | | | | | |
| | Thermal Stabilizer | | derivative | | | | | |
| | | ADK STAB ZS-27 | Metal Deactivator | | 1.0 | | | |
| | | (ADEKA Corporation) | Complex Type | | | | | |
| | | Irganox MD1024 | Metal Deactivator | | | 1.0 | | |
| | | (Ciba Specialty Chemicals | Hydrazine derivative | | | | | |
| | | Inc.) | | | | | | |
| | | Naugard XL-1 | Metal Deactivator | | | | 1.5 | |
| | | (Uniroyal Chemicals Ltd.) | Oxalic acid derivative | | | | | |
| | | Nocrac White | Metal Deactivator | | | | | 1.5 |
| | | (Ouchi Shinko Chemical | Amine-based | | | | | |
| | | Industrial Co., Ltd.) | | | | | | |
| | | Irganox B1171 | Photo-Thermal Stabilizer | 0.8 | 0.7 | 0.8 | 0.6 | 0.8 |
| | | (Ciba Specialty Chemicals | Hindered Phenolic | | | | | |
| | | Inc.) | | | | | | |
| | (e) Viscosity | Adipic Acid | Reagent | 0.3 | 0.4 | 0.4 | 0.4 | 0.3 |
| | regulator | | | | | | | |

TABLE 2

| | | | Comparative | Comparative | Comparative | Comparative |
|---|---|---|---|---|---|---|
| | | | Example 1 | Example 2 | Example 3 | Example 4 |
| Resin | (a) Polyamide | recycled nylon 66 | | 40 | | |
| Composition | | ( ) shows ion content of | | (24 PPM) | | |
| | | contained copper | | | | |
| | | nylon 6 | 70 | 40 | 98 | 70 |
| | (b) Modified | Maleic anhydride-modified | | | | |
| | Polypropylene | polypropylene | | | | |
| | (c) Reinforcement | Talc | 20 | 20 | | 20 |
| | Material | Mica | | | | |
| | | Glass Fiber | 10 | | | 10 |
| | | Others | | | 2 | |
| | (d) Metal | ADK STAB CDA-1 | | | | |
| | Deactivator/ | (ADEKA Corporation) | | | | |
| | Photo-Thermal | ADK STAB ZS-27 | | | | |
| | Stabilizer | (ADEKA Corporation) | | | | |
| | | Irganox MD1024 | | | | |
| | | (Ciba Specialty Chemicals | | | | |
| | | Inc.) | | | | |
| | | Naugard XL-1 | | | | |
| | | (Uniroyal Chemicals Ltd.) | | | | |
| | | Nocrac White | | | | |
| | | (Ouchi Shinko Chemical | | | | |
| | | Industrial Co., Ltd.) | | | | |
| | | Irganox B1171 | 0.4 | 0.4 | 0.4 | 0.4 |
| | | (Ciba Specialty Chemicals | | | | |
| | | Inc.) | | | | |
| | (e) Viscosity | Adipic Acid | | | | |
| | regulator | | | | | |
| | | | Comparative | Comparative | Comparative | Comparative |
| | | | Example 5 | Example 6 | Example 7 | Example 8 |
| Resin | (a) Polyamide | recycled nylon 66 | 30 | 30 | | 45 |
| Composition | | ( ) shows ion content of | (18 ppm) | (18 ppm) | | (27 ppm) |
| | | contained copper | | | | |
| | | nylon 6 | 30 | 30 | 60 | 40 |
| | (b) Modified | Maleic anhydride-modified | 27 | 27 | 27 | 5 |
| | Polypropylene | polypropylene | | | | |
| | (c) Reinforcement | Talc | 8 | 8 | | |
| | Material | Mica | | | 5 | 5 |
| | | Glass Fiber | 5 | 5 | 8 | 5 |
| | | Others | | | | |
| | (d) Metal | ADK STAB CDA-1 | | 1.5 | | |
| | Deactivator/ | (ADEKA Corporation) | | | | |
| | Photo-Thermal | ADK STAB ZS-27 | | | | |
| | Stabilizer | (ADEKA Corporation) | | | | |
| | | Irganox MD1024 | | | | 1.0 |
| | | (Ciba Specialty Chemicals | | | | |
| | | Inc.) | | | | |
| | | Naugard XL-1 | | | | |
| | | (Uniroyal Chemicals Ltd.) | | | | |
| | | Nocrac White | | | | |
| | | (Ouchi Shinko Chemical | | | | |
| | | Industrial Co., Ltd.) | | | | |
| | | Irganox B1171 | 0.4 | 0.4 | 0.4 | 0.4 |
| | | (Ciba Specialty Chemicals | | | | |
| | | Inc.) | | | | |
| | (e) Viscosity | Adipic Acid | 0.3 | | 0.3 | 0.4 |
| | regulator | | | | | |

The polyamide resin composition thus obtained was pelletized using an injection molding machine, thus forming measurement samples (test pieces). The molding conditions for the production of test pieces included the cylinder temperature as in measurement of MFR in the examples and comparative examples of Tables 3 and 4 below, and the mold temperature of 70° C.

The characteristics and properties of the respective test pieces of Examples 1˜5 and Comparative Examples 1˜8 were measured according to the following methods. The results are shown in Tables 3 and 4 below.

### (1) Flexural Modulus

The flexural modulus was measured according to ISO-178.

### (2) Melting Point

The melting point was measured using a differential scanning calorimeter. For measurement, each sample was loaded in a dry state of moisture content of 0.03% or less into the differential scanning calorimeter and then sealed, in order to prevent the change in melting point due to moisture. Thereafter, when the temperature was increased to 300° C. at a heating rate of 20° C./min under nitrogen flow, an endothermic peak based on crystal fusion at the temperature was measured, and the top of the peak was determined to be the melting point.

### (3) Melt Flow Rate (MFR)

The MFR was measured according to JIS K-7210. Specifically, the amount (g) of resin flowing for 10 min under a load of 2160 g at a temperature 10° C. higher than the melting point of the component (a) was measured. As such, each sample was loaded in a dry state of moisture content of 0.03% or less into a measurement system and then sealed, in order to prevent the change in MFR due to moisture.

### (4) Thermal Degradation Temperature

The thermal degradation temperature was measured according to JIS K-7210, under a load of 0.46 MPa at a heating rate of 2° C./min.

### (5) Specific Gravity

The specific gravity was measured according to ASTM D-792. The measurement was conducted in ethanol using the cut-out piece of an injection molded product as a measurement sample.

### (6) Saturated Moisture Content

The saturated moisture content was determined by measuring an equilibrium moisture absorption rate at 65% relative humidity. For measurement, the test piece used in the flexural test was allowed to stand in a thermohydrostatic chamber at a temperature of 50° C. and a relative humidity of 65% until changes in mass from the initial mass were uniform, and the moisture absorption rate was calculated from the increment of the mass.

### (7) Flexural Modulus Under Actual Use

The flexural modulus under actual use (flexural modulus under equilibrium moisture absorption at 65% relative humidity) was determined by conducting the flexural test under initial conditions using a test piece to which moisture had been absorbed as in the measurement of the saturated moisture content.

### (8) Material Properties

<Flexural Modulus Maintenance>

The test piece prepared in the measurement of (1) was stored under the conditions of (6), and the flexural modulus under actual use was measured through the method of (7). From this result, the flexural modulus maintenance of initial characteristic was determined through the following equation and evaluated according to the following criteria.

Flexural modulus maintenance={[(initial flexural modulus)−(each flexural modulus under actual use)]/(initial flexural modulus)}×100(%)

∘: maintenance of 60% or more

x: maintenance

of less than 60%

### (9) Moldability of Engine Cover

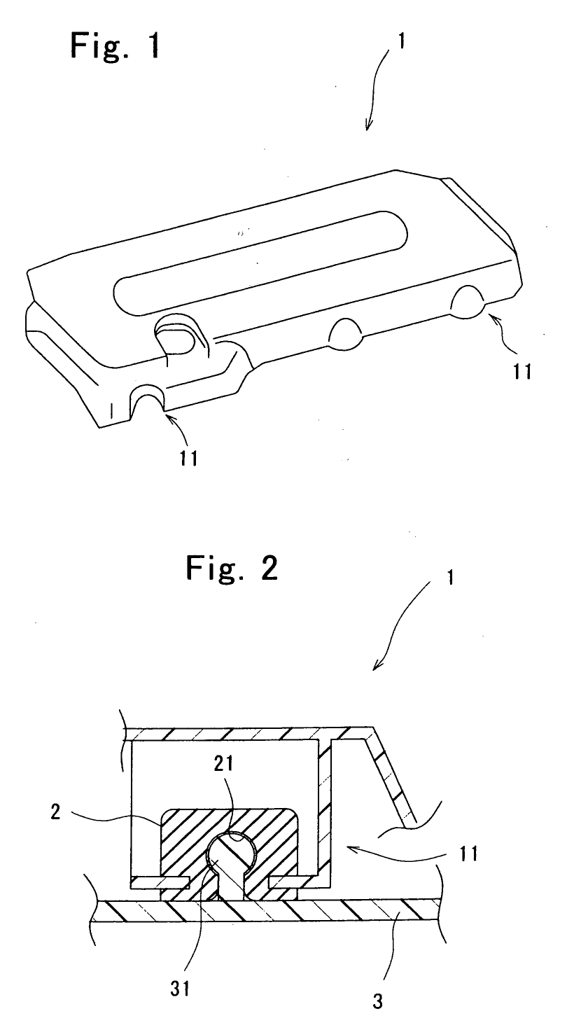

An engine cover 1 of FIG. 1 was injection molded from the above resin composition. The engine cover 1 is in the form of an approximately rectangular-shaped plate having close to the uniform thickness and is provided with fixing portions 11 having internal empty spaces at four corners of the rear surface thereof. In the bottom surface of each of the fixing portions 11, a through hole is formed, and an elastic member 2 is held in the through hole. The elastic member 2 is provided with a fixing hole 21 at the center thereof, the fixing hole having a pathway that is open downwards and having an enlarged portion with a diameter greater than the diameter of the pathway. As shown in the partially enlarged cross-sectional view of FIG. 2, the engine cover 1 may be attached to a cylinder head cover 3 by fitting an attachment 31 protruding from each of the four corners of the head cover 3 into the fixing hole 21 of the elastic member 2.

In the injection molding of the engine cover 1, injection molding was conducted using the mold having the shape of the engine cover at the cylinder temperature as in the measurement of MFR in the examples of Table 3 and the comparative examples of Table 4. At this time, the filling pressure and the outer appearance were observed and evaluated according to the following criteria. In Examples 1˜5 and Comparative Examples 4˜8, the average thickness of the engine cover 1 was 1.8 mm, and in Comparative Examples 1˜3 the average thickness of the engine cover 1 was 2.5 mm.

<Evaluation Criteria of the Ease of Filling>

∘: injection pressure of less than 80 MPa

x: injection pressure of 80 MPa or more

<Evaluation Criteria of Outer Appearance>

∘: no problem in color and outer appearance

x: problems of shrinkage, wrinkle, etc.

### (10) Mass Reduction of Engine Cover

On the basis of the mass of the engine cover of Comparative Example 1 (specific gravity of resin: 1.41, average thickness: 2.5 mm) among the engine covers of the examples of Table 3 and the comparative examples of Table 4, a mass reduction rate was determined through the following equation and evaluated as follows.

Mass Reduction Rate={[(mass of engine cover of C. Ex. 1−mass of each engine cover)]/(mass of engine cover of C. Ex. 1)}×100(%)

⊚: mass reduction rate of 30% or more

∘: mass reduction rate of 25% or more but less than 30%

x: mass reduction rate of less than 25%

### (11) Functions of Engine Cover

<Flexural Modulus Under Actual Use>

The engine cover molded as in (9) was stored under actual use conditions (saturated moisture content: equilibrium moisture absorption rate at 65% relative humidity), and then five test pieces were randomly cut out from the above engine cover, after which flexural modulus was measured at n=5 and evaluated according to the following criteria.

∘: average flexural modulus of five cut-out test pieces of 2.5 GPa or more

x: average flexural modulus of five cut-out test pieces of less than 2.5 GPa

<Thermal Deformation Temperature Under Actual Use>

The engine cover molded as in (9) was stored under actual use conditions (saturated moisture content: equilibrium moisture absorption rate at 65% relative humidity), five test pieces were randomly cut out from the above engine cover, and measurement was conducted at n=5 at a heating rate of 2° C./min under a load of 0.46 MPa according to JIS K-7207. The results were evaluated according to the following criteria.

⊚: 180° C. or higher

∘: 170° C. or higher but lower than 180° C.

x: lower than 170° C.

<Thermal Aging Resistance of Engine Cover>

For the shape of the engine cover as in (9), 100 parts by mass of the resin composition of each of the examples and comparative examples was mixed with 1.5 parts by mass of carbon black, after which the mixture thus obtained was injection molded, thus producing a black engine cover. This cover was stored at 150° C. for 360 hours. Then, the changes in outer appearance, shape, and black color of the cover were observed and evaluated according to the following criteria.

∘: warpage of the cover of less than 3.0 mm, no change in black color

x: warpage of the cover of 3.0 mm or more, generation of portion changed to white color from black color

### (12) Conclusion

In the case where all items including the material properties, moldability, mass reduction of engine cover, and functions of engine cover of Tables 1 and 4 were evaluated to be ⊚ or ∘, the engine cover was judged to be ∘, and in the case where even any one among the above items was evaluated to be x, the engine cover was judged to be x.

The respective evaluation criteria are summarized in Table 5 below.

TABLE 3

| | | Remark | Example 1 | Example 2 | Example 3 | Example 4 | Example 5 |
|---|---|---|---|---|---|---|---|
| Resin | MFR (Melt Flow Rate) | Measured Temperature (° C.), | 275.52 | 275.48 | 275.67 | 275.75 | 275.50 |
| Characteristic | | MFR; g/10 min | | | | | |
| | Specific Gravity | | 1.16 | 1.16 | 1.16 | 1.16 | 1.16 |
| | Saturated Moisture Content (%) | | 1.8 | 1.8 | 2.3 | 2.4 | 1.8 |
| | Initial Properties | Flexural Modulus (GPa) | 3.8 | 4 | 3.7 | 3.6 | 3.7 |
| | Under Actual Use = Under | Flexural Modulus (GPa) | 2.8 | 3.1 | 2.5 | 2.4 | 2.7 |
| | Saturated Moisture Absorption | Maintenance of Initial | 74 | 78 | 68 | 67 | 73 |
| | (Change of properties with | Characteristic (%) | ◯ | ◯ | ◯ | ◯ | ◯ |
| | aging) | | | | | | |
| Moldability | | Average Thickness (mm) | 1.8 | 1.8 | 1.8 | 1.8 | 1.8 |
| | | Filling | ◯ | ◯ | ◯ | ◯ | ◯ |
| | | Outer Appearance | ◯ | ◯ | ◯ | ◯ | ◯ |
| Mass Reduction | Mass Ratio (On the basis of | Average Thickness (mm) | 1.8 | 1.8 | 1.8 | 1.8 | 1.8 |
| of Engine | the material of Comparative | Mass Reduction Ratio (%) | 41 | 41 | 41 | 41 | 41 |
| Cover | Example 1) | Judgment | ⊚ | ⊚ | ⊚ | ⊚ | ⊚ |
| Functions of | Under Actual Use = Rigidity of | Flexural Modulus (GPa) | 2.9 | 3.2 | 2.6 | 2.5 | 2.8 |
| Engine Cover | Product Under Saturated | | ◯ | ◯ | ◯ | ◯ | ◯ |
| | Moisture Absorption | Thermal Deformation Temperature | 186 | 192 | 177 | 171 | 185 |
| | (Cut-out test piece) | (° C.) (Load 0.45 MPa) | | | | | |
| | | Judgment | ⊚ | ⊚ | ◯ | ◯ | ⊚ |
| | Heat Resistance | (150° C. × 360 h) No change in outer | ◯ | ◯ | ◯ | ◯ | ◯ |
| | | appearance and color | | | | | |

| | | | | | |
|---|---|---|---|---|---|
| Total Evaluation | ◯ | ◯ | ◯ | ◯ | ◯ |

TABLE 4

| | | | Comparative | Comparative | Comparative | Comparative |
|---|---|---|---|---|---|---|
| | | | Example 1 | Example 2 | Example 3 | Example 4 |
| | MFR (Melt Flow Rate) | Measured Temperature (° C.), | 275.15 | 275.38 | 235.16 | 275.15 |
| | | MFR; g/10 min | | | | |
| Resin | Specific Gravity | | 1.41 | 1.28 | 1.15 | 1.41 |
| Characteristic | Saturated Moisture | | 2.5 | 2.4 | 3.2 | 1.8 |
| | Content (%) | | | | | |
| | Initial Properties | Flexural Modulus (GPa) | 6.7 | 4.4 | 3.7 | 6.7 |
| | Under Actual Use = Under | Flexural Modulus (GPa) | 3.8 | 2.4 | 1.3 | 3.8 |
| | Saturated Moisture | Maintenance of Initial | 57 | 55 | 35 | 57 |
| | Absorption | Characteristic (%) | X | X | X | X |
| | (Change of properties | | | | | |
| | with aging) | | | | | |
| Moldability | | Average Thickness (mm) | 2.5 | 2.5 | 2.5 | 1.8 |
| | | Filling | ◯ | ◯ | ◯ | X |
| | | Outer Appearance | X | X | X | X |
| Mass Reduction | Mass Ratio (On the basis | Average Thickness (mm) | 2.5 | 2.5 | 2.5 | 1.8 |
| of Engine | of the material of | Mass Reduction Ratio (%) | — | 9 | 19 | 28 |
| Cover | Comparative Example 1) | Judgment | — | X | X | ◯ |
| Functions of | Under Actual | Flexural Modulus (GPa) | 3.7 | 2.2 | 1.2 | 3.5 |
| Engine Cover | Use = Rigidity of Product | | ◯ | X | X | ◯ |
| | Under Saturated Moisture | Thermal Deformation | 176 | 172 | 155 | 174 |
| | Absorption | Temperature (° C.) | | | | |
| | (Cut-out test piece) | Judgment | ◯ | ◯ | X | ◯ |
| | Heat Resistance | (150° C. × 360 h) | ◯ | ◯ | ◯ | ◯ |
| Total Evaluation | | | X | X | X | X |
| | | | Comparative | Comparative | Comparative | Comparative |
| | | | Example 5 | Example 6 | Example 7 | Example 8 |
| | MFR (Melt Flow Rate) | Measured Temperature (° C.), | 275.50 | 275.30 | 235.52 | 275.66 |
| | | MFR; g/10 min | | | | |
| Resin | Specific Gravity | | 1.16 | 1.16 | 1.16 | 1.20 |
| Characteristic | Saturated Moisture | | 1.8 | 1.8 | 1.9 | 2.8 |
| | Content (%) | | | | | |
| | Initial Properties | Flexural Modulus (GPa) | 3.7 | 3.7 | 3.8 | 4.1 |
| | Under Actual Use = Under | Flexural Modulus (GPa) | 2.7 | 2.7 | 2.8 | 2.1 |
| | Saturated Moisture | Maintenance of Initial | 73 | 73 | 74 | 51 |
| | Absorption | Characteristic (%) | ◯ | ◯ | ◯ | X |
| | (Change of properties | | | | | |
| | with aging) | | | | | |
| Moldability | | Average Thickness (mm) | 1.8 | 1.8 | 1.8 | 1.8 |
| | | Filling | ◯ | X | ◯ | ◯ |
| | | Outer Appearance | ◯ | X | ◯ | ◯ |
| Mass Reduction | Mass Ratio (On the basis | Average Thickness (mm) | 1.8 | 1.8 | 1.8 | 1.8 |
| of Engine | of the material of | Mass Reduction Ratio (%) | 41 | 41 | 41 | 39 |
| Cover | Comparative Example 1) | Judgment | ⊚ | ⊚ | ⊚ | ◯ |
| Functions of | Under Actual | Flexural Modulus (GPa) | 2.8 | 2.8 | 2.7 | 2 |
| Engine Cover | Use = Rigidity of Product | | ◯ | ◯ | ◯ | X |
| | Under Saturated Moisture | Thermal Deformation | 185 | 185 | 130 | 165 |
| | Absorption | Temperature (° C.) | | | | |
| | (Cut-out test piece) | Judgment | ⊚ | ⊚ | X | X |
| | Heat Resistance | (150° C. × 360 h) | X | ◯ | ◯ | ◯ |

| | | | | |
|---|---|---|---|---|
| Total Evaluation | X | X | X | X |

TABLE 5

| | | | Evaluation Criteria |
|---|---|---|---|
| Resin | Specific Gravity | | — |
| Characteristic | Saturated Moisture Content (%) | | — |
| | Initial Properties | Flexural Modulus (GPa) | — |
| | Under Actual Use = Under Saturated | Flexural Modulus (GPa) | — |
| | Moisture Absorption | Maintenance of Initial | ◯: maintenance of 60% or more |
| | (Change of properties with aging) | Characteristic (%) | X: maintenance of less than 60% |
| Moldability | Average Thickness (mm) | Filling | ◯: injection pressure of less than 80 MPa |
| | | | X: injection pressure of 80 MPa or more |
| | | Outer Appearance | ◯: no problem in color and outer appearance |
| | | | X: problems of shrinkage, wrinkle, etc. |
| Mass | Mass Ratio (On the basis of the | | ⊚: mass reduction rate of 30% or more |
| Reduction of | material of Comparative Example 1) | | ◯: mass reduction rate of 25% or more but less than 30% |
| Engine Cover | | | X: mass reduction rate of less than 25% |
| Functions of | Under Actual Use = Rigidity of | Flexural Modulus (GPa) | ◯: 2.5 GPa or more |
| Engine Cover | Product Under Saturated Moisture | | X: less than 2.5 GPa |
| | Absorption | Thermal Deformation | ⊚: 180° C. or higher |
| | (Cut-out test piece) | Temperature (° C.) | ◯: 170° C. or higher but lower than 180° C. |
| | Measuring equilibrium moisture | (Load 0.45 MPa) | X: lower than 170° C. |
| | absorption sample under storing at | | |
| | 50° C. × 65% relative humidity | | |
| | Heat Resistance | (150° C. × 360 h) | ◯: warpage of the cover of less than 3.0 mm, no change |
| | | | in black color |
| | | | X: warpage of the cover of 3.0 mm or more, generation |
| | | | of portion changed to white color from black color |

As is apparent from Tables 3 and 4, in all of Examples 1˜5, the material having a low specific gravity was used and thus the flexural modulus maintenance under saturated moisture absorption thereof was high. Furthermore, during injection molding, the ease of filling the mold having the shape of the thin-walled cover having an average thickness of 1.8 mm was good, resulting in a good outer appearance. Because this engine cover product was thin using material with a low specific gravity, it was greatly reduced in mass so as to be well adapted for use as an engine cover. As for the functions of the engine cover, the flexural modulus maintenance under actual use (=equilibrium moisture absorption at 50° C.×65% relative humidity) was high and the rigidity of the cover was also high. This engine cover had a high thermal deformation temperature and good thermal aging resistance under storage at 150° C. Furthermore, the engine cover exhibited good impact resistance able to endure vibration of the engine, and therefore, the properties of the engine cover could be estimated to be considerably balanced.

In particular, in Examples 1, 2, and 5, in which the components (a)˜(c) were mixed at a mass ratio of (a)/(b)/(c) of 50˜70/20˜30/10˜20 and the proportion of the component (b) was 20 or more, the equilibrium moisture absorption rate (saturated moisture content) at 65% relative humidity was decreased to 1.8, and thus, under actual use (under saturated moisture absorption), the flexural modulus increased to 2.8 GPa or more, and the thermal deformation temperature increased to 180° C. or higher.

Comparative Example 1, in which the recycled nylon 66 and the modified polypropylene resin were not used and the thickness of the engine cover was grater than 2.0 mm, was excluded from the scope of the present invention, and the specific gravity of the material was high, thus the engine cover was heavy. Also, the flexural modulus maintenance and the outer appearance were evaluated to be poor.

Comparative Example 2, in which the thickness of the engine cover was greater than 2.0 mm, was excluded from the scope of the present invention, and the flexural modulus maintenance, the mass reduction rate, and the outer appearance were evaluated to be poor.

Comparative Example 3, in which the recycled nylon 66 and the modified polypropylene resin were not used, the proportion of the reinforcement material (c) fell outside of the inventive range, and if the thickness of the engine cover was greater than 2.0 mm, it was excluded from the scope of the present invention, and the flexural modulus maintenance, the mass reduction rate, and the outer appearance were evaluated to be poor.

Comparative Example 4, in which the recycled nylon 66 and the modified polypropylene resin were not used, was excluded from the scope of the present invention, and the MFR was small and thus the ease of filling during injection molding and the outer appearance were evaluated to be poor. Also, the flexural modulus maintenance was evaluated to be poor.

Comparative Example 5, in which the metal deactivator was not used, was excluded from the scope of the present invention, and the resin composition was thermally degraded after storage at 150° C. and the engine cover was whitened.

Comparative Example 6, in which the viscosity regulator was not used and the MFR was less than 40 g/10 min, was excluded from the scope of the present invention, and the ease of filling during injection molding and the outer appearance were evaluated to be poor.

Comparative Example 7, in which the recycled nylon 66 was not used, was excluded from the scope of the present invention, and the thermal deformation temperature under actual use in a state of saturated moisture absorption was low and thus this engine cover product greatly changed in shape after storage at 150° C., and was unsuitable for use as an engine cover.

In Comparative Example 8, the mixing ratio of (a)/(b)/(c) fell outside of the inventive range, and the thermal deformation temperature under actual use in a state of saturated moisture absorption was low, and thus this engine cover product greatly changed in shape after storage at 150° C., and was unsuitable for use as an engine cover. Furthermore, the flexural modulus maintenance was evaluated to be poor.

<Charpy Impact Strength>

The Charpy impact strength of each test piece of Examples 1˜5 was measured according to ISO-179. Table 6 below shows the charpy impact strength (KJ/m²) (notched) of Examples 1˜5.

TABLE 6

| | | Item | Example 1 | Example 2 | Example 3 | Example 4 | Example 5 |
|---|---|---|---|---|---|---|---|
| Resin | Initial | Charpy Impact Strength | 3.7 | 3.7 | 3.5 | 3.5 | 3.7 |
| Characteristic | Properties | (KJ/m²) (notched) | | | | | |

As is apparent from Table 6, in Examples 3 and 4 in which the MFR was greater than 65 g/10 min, the Charpy impact strength was 3.5 kJ/m², whereas in Examples 1, 2 and 5 in which the MFR was not greater than 55 g/10 min, the Charpy impact strength was 3.7 kJ/m². Therefore, when the MFR was not greater than 55 g/10 min, impact resistance as an initial resin property could be seen to be improved.

While the invention has been shown and described with respect to the preferred embodiments, it will be understood by those skilled in the art that various changes and modification may be made without departing from the spirit and scope of the invention as defined in the following claims.

1. A thin-walled light engine cover for vehicles, which is produced from a resin composition, the resin composition comprising:
(a) a polyamide resin composed of essentially at least one of scrap of vehicle airbag fabric made of nylon 66 containing a copper-based stabilizer and recycled vehicle airbag fabric made of nylon 66 containing a copper-based stabilizer;
(b) a modified polypropylene resin, obtained by graft copolymerizing an unsaturated carboxylic acid or a derivative thereof onto a crystalline polypropylene resin;
(c) a reinforcement material;
(d) a metal deactivator and a photo-thermal stabilizer; and
(e) a viscosity regulator; wherein:
in the resin composition, the components (a)˜(c) are mixed at a mass ratio of (a)/(b)/(c) of 45˜80/15˜35/5˜20;
in the resin composition, based on 100 parts by mass of a total of the components (a)˜(c), the component (d) is used in an amount of 0.005˜10 parts by mass and the component (e) is used in an amount of 0.05˜10 parts by mass;
the resin composition has a melt flow rate of not less than 40 g/10 min, which is measured under a load of 2160 g at a temperature 10° C. higher than a melting point of the component (a) as obtained through differential scanning calorimetry at a heating rate of 20° C./min; and
the engine cover has an average thickness of 2.0 mm or less.

2. The engine cover as set forth in claim 1, wherein the metal deactivator is at least one element and/or a composite comprising two or more elements selected from the group consisting of salicylic acid derivatives, hydrazine derivatives, oxalic acid derivatives, and diamine derivatives, and the photo-thermal stabilizer is at least one selected from the group consisting of hindered phenolic stabilizers, phosphorus-based stabilizers, benzotriazole-based stabilizers, benzophenone-based stabilizers, and amine-based stabilizers.

3. The engine cover as set forth in claim 1, wherein the viscosity regulator is at least one selected from the group consisting of aliphatic dicarboxylic acids, alicyclic dicarboxylic acids, and aromatic dicarboxlic acids.

4. The engine cover as set forth in claim 1, wherein the reinforcement material comprises a plate-like inorganic filler and a fibrous reinforcement material.

5. The engine cover as set forth in claim 4, wherein the plate-like inorganic filler and the fibrous reinforcement material are mixed at a mass ratio of plate-like inorganic filler/fibrous reinforcement material of 35˜65/35˜65.

6. The engine cover as set forth in claim 1, wherein a flexural modulus under equilibrium moisture absorption at 65% relative humidity is 2.5 GPa or more.

7. The engine cover as set forth in claim 1, wherein an equilibrium moisture absorption rate at 65% relative humidity is 2.5% or less.
